(19) United States
(12) Patent Application Publication
(10) Pub. No.: US 2025/0363681 A1
(43) Pub. Date: Nov. 27, 2025

(54) METHOD, APPARATUS, ELECTRONIC DEVICE AND STORAGE MEDIUM FOR PROCESSING IMAGE

(71) Applicant: Beijing Zitiao Network Technology Co., Ltd., Beijing (CN)

(72) Inventor: Qiuyu WANG, Beijing (CN)

(21) Appl. No.: 18/873,205

(22) PCT Filed: Jun. 15, 2023
(86) PCT No.: PCT/CN2023/100326

§ 371 Date: Dec. 9, 2024

(30) Foreign Application Priority Data
Jun. 28, 2022 (CN) 202210751838.9

(51) Int. Cl. G06T 11/00; G06T 7/40

(52) U.S. Cl. CPC G06T 11/001; G06T 7/40; G06T 2207/10016; G06T 2207/20081

(57) ABSTRACT

Embodiments of the disclosure provide a method, apparatus, electronic device and storage medium for processing image, and the method includes: obtaining an image to be processed; determining an object structural feature within the image to be processed corresponding to a target object and determining a style texture feature corresponding to a reference style image to be applied; and determining a target style image corresponding to the image to be processed based on the object structural feature and the style texture feature.

The present disclosure claims priority to Chinese Patent Application No. 202210751838.9, filed on Jun. 28, 2022, the entirety of which is incorporated herein by reference.

### FIELD

Embodiments of the present disclosure relate to the technical field of processing image, in particular to a method, apparatus, electronic device and storage medium for processing image.

### BACKGROUND

With the demand for richness on contents of pictures from users, corresponding effect props or image processing algorithms are often needed to process the collected images into effect images under a certain style type.

However, contents of the effect images obtained by related technical processing are incomplete, resulting in poor display effect of the effect images and causing poor user experience.

### SUMMARY

The present disclosure provides a method, apparatus, electronic device and storage medium for processing image, so that the comprehensiveness of image content processing is realized, and the user watching experience is improved.

In a first aspect, the embodiments of the present disclosure provide a method for processing image. The method includes:
obtaining an image to be processed;
determining an object structural feature within the image to be processed corresponding to a target object and
determining a style texture feature corresponding to a reference style image to be applied; and
determining a target style image corresponding to the image to be processed based on the object structural feature and the style texture feature.

In a second aspect, the embodiments of the present disclosure further provide an apparatus for processing image. The apparatus includes:
a to-be-processed image obtaining module configured to obtain an image to be processed;
a feature extracting module configured to determine an object structural feature within the image to be processed corresponding to a target object and determine a style texture feature corresponding to a reference style image to be applied; and
a style image determining module configured to determine a target style image corresponding to the image to be processed based on the object structural feature and the style texture feature.

In a third aspect, the embodiments of the present disclosure further provide an electronic device. The electronic device includes:
one or more processors; and
a storage device configured to store one or more programs,
wherein the one or more programs, when executed by the one or more processors, cause the one or more processors to implement a method for processing image according to any of the embodiments of the present disclosure.

In a fourth aspect, the embodiments of the present disclosure further provide a storage medium including computer-executable instructions, wherein the computer-executable instructions, when executed by a computer processor, perform a method for processing image according to any of the embodiments of the present disclosure.

### BRIEF DESCRIPTION OF DRAWINGS

Throughout the drawings, the same or similar reference numerals represent the same or similar elements. It should be understood that the drawings are schematic, and components and elements are not necessarily drawn to scale.

FIG. 1 is a schematic flowchart of a method for processing image provided by the embodiments of the present disclosure;

FIG. 2 is a schematic diagram of a display interface provided by the embodiments of the present disclosure;

FIG. 3 is a schematic flowchart of a method for processing image provided by the embodiments of the present disclosure;

FIG. 4 is a schematic structural diagram of an encoder provided by the embodiments of the present disclosure;

FIG. 5 is a schematic flowchart of a method for processing image provided by the embodiments of the present disclosure;

FIG. 6 is a schematic flowchart of a method for processing image provided by the embodiments of the present disclosure;

FIG. 7 is a schematic diagram of processing image provided by the embodiments of the present disclosure;

FIG. 8 is a schematic flowchart of training to obtain an image generative model provided by the embodiments of the present disclosure;

FIG. 9 is a structural block diagram of an apparatus for processing image provided by the embodiments of the present disclosure; and

FIG. 10 is a schematic structural diagram of an electronic device provided by the embodiments of the present disclosure.

### DETAILED DESCRIPTION

Embodiments of the present disclosure will be described below with reference to the accompanying drawings. While some embodiments of the present disclosure are shown in the drawings, it should be understood that the present disclosure may be implemented in various forms. It should be understood that the drawings and embodiments of the present disclosure are for illustrative purposes only.

It should be understood that the steps described in the method embodiments of the present disclosure may be performed in a different order and/or in parallel. Furthermore, the method embodiments may include additional steps and/or omit performing the illustrated steps.

As used herein, the term “include” and its variants should be construed as open terms meaning “including, but not limited to”. The term “based on” means “at least partially based on”. The term “one embodiment” means “at least one embodiment”. The term “another embodiment” means “at least one another embodiment”. The terms “some embodiments” means “at least some embodiments”. Related definitions of other terms will be given in the following descriptions.

It should be noted that the concepts of “first”, “second” and the like mentioned in the present disclosure are used only to distinguish different apparatuses, modules or units but not to limit the order or interdependence of the functions performed by these apparatuses, modules or units.

It should be noted that the modifications of “a” and “a plurality” mentioned in the present disclosure are schematic rather than limiting, and it should be understood by those skilled in the art that unless otherwise explicitly stated in the context, they should be understood as “one or more”.

The names of messages or information interaction between multiple apparatuses in embodiments of the present disclosure are for illustrative purposes only and are not intended to limit the scope of such messages or information.

It is to be understood that, before applying the technical solutions disclosed in various embodiments of the present disclosure, the user should be informed of the type, scope of use, and use scenario of the personal information involved in the subject matter of the present disclosure in an appropriate manner in accordance with relevant laws and regulations, and user authorization should be obtained.

For example, in response to receiving an active request from the user, prompt information is sent to the user to explicitly inform the user that the requested operation would obtain and use the user's personal information. Therefore, according to the prompt information, the user may decide on his/her own whether to provide the personal information to the software or hardware, such as electronic devices, applications, servers, or storage medium that perform operations of the technical solutions of the present disclosure.

As an optional but non-limiting implementation, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative and does not limit the implementations of the present disclosure. Other methods that satisfy relevant laws and regulations are also applicable to the implementations of the present disclosure.

It is to be understood that data involved in the present technical solution (including but not limited to the data itself, the acquisition or use of the data) should comply with requirements of corresponding laws and regulations and relevant rules.

Before the technical solution is introduced, the application scenario may be described first. The technical solutions of the present disclosure may be applied to any process in which an image needs to be processed, for example, in a video capturing process, an effect display may be performed on an image corresponding tothe user being captured, for example, in a short video capturing scenario. It can also be integrated in any image capturing scenario, for example, in a camera with a built-in capturing function in the system, so that after the image to be processed is captured, the target effect image corresponding to the image to be processed can be determined based on the technical solution provided by the embodiments of the present disclosure. It can also be used to process the screen recording video to obtain the effect of the effect video corresponding to the non-real-time recorded video.

It should be noted that there is also a certain style image processing model, for example, a generative adversarial network (GAN) model. The style image processing model is trained to obtain, a large amount of stylized sample data and a corresponding algorithm are needed to realize the style transfer of the non-paired data, that is, the mode depends on thousands of stylized images, the stylized image needs to be manually drawn, time and labor are wasted, and it is difficult to train to obtain the style image processing model corresponding to a style feature. The style image processing model of the related art also has poor styled effect for a large angle and a large expression facial image. Finally, the image processing model of the related art also only performs stylization on the face image of the target object, and does not perform wind stylization processing on the background, resulting in a technical problem that the target object after effect processing does not line the background content, causing poor display of the image effect.

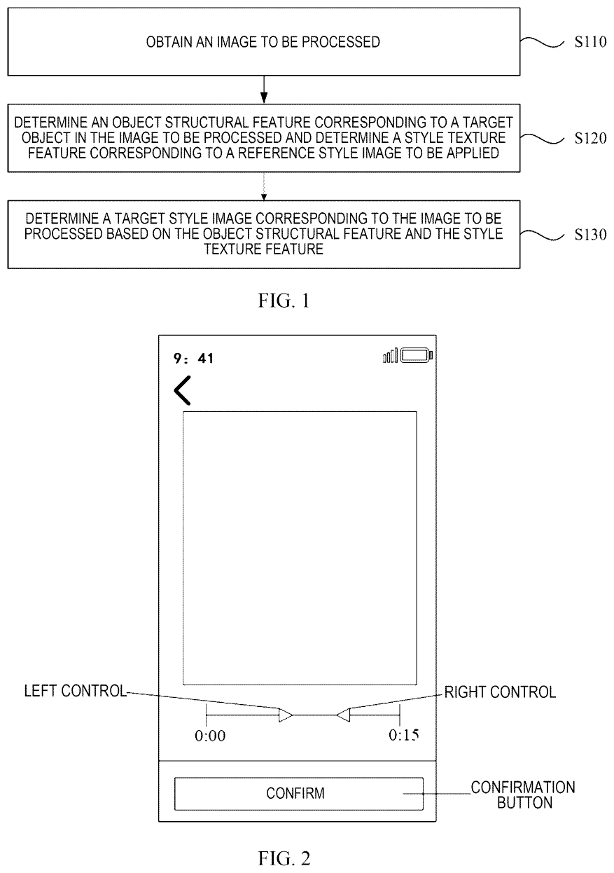

FIG. 1 is a schematic flowchart of a method for processing image provided by the embodiments of the present disclosure. The present disclosure embodiment is applicable to the case where a target object and background image in the image to be processed are processed into effect images corresponding to a style texture feature. The method may be executed by an apparatus for image processing, which can be implemented in software and/or hardware, and optionally, through an electronic device, which can be a mobile terminal, a personal computer (PC) end, or a server, etc.

As shown in FIG. 1, the method includes the following steps.

At S110, obtain an image to be processed.

Herein, the image to be processed may be an image captured by the user by using the capturing apparatus or may be any video frame in the video that is captured in advance. It may be understood that the image to be processed may be an image captured by the user in real time based on the capturing software on the mobile terminal, or may be an image selected by the user that has completed capturing. Certainly, the recorded video may be processed. Optionally, after the recorded video may be uploaded, each video frame in the recorded video may be processed, and at this time, each video frame is used as the image to be processed.

As an example, obtaining the image to be processed may include: capturing an image in the real scene by using a camera on the mobile terminal, and determining the captured image as the image to be processed; or may be processing the captured recorded video, and determining the video frame in the recorded video as the image to be processed.

On the basis of the above technical solution, obtaining the image to be processed includes: in response to detecting that an effect processing operation is triggered, collecting the image to be processed; or determining at least one video frame within an uploaded video to be processed as the image to be processed.

It should be noted that the manner of obtaining the image to be processed includes at least two manners. The first manner is to collect the image to be processed in real time, and the second manner is to use the video frame in the screen recording video as the image to be processed.

The following will describe how the two manners determine the image to be processed.

Herein, the effect processing operation is an operation that needs to perform effect processing on the image to be processed. The effect processing operation may include triggering the effect prop; after an effect capturing control is triggered, it is determined that the effect processing operation is triggered as long as it is detected that the entry image includes the target object. If it is determined that an effect processing wake-up word is triggered based on audio information collect in real time, it is determined that the image to be processed needs to be processed as the corresponding effect image; and if it is determined that a preset action is triggered based on body motion information collected in real time, it is determined that the image to be processed needs to be processed as the corresponding effect image.

In a first manner, if it is detected that an effect processing operation is triggered, the image to be processed may be collected in real time, and the collected image to be processed is sequentially processed according to the method provided in the embodiments of the present disclosure, to obtain a final target effect video.

Herein, the video to be processed is a recorded video and needs to be performed effect processing. The video to be processed is composed of a plurality of video frames, and each video frame may be used as an image to be processed.

In a second manner, if it is detected that the user triggers a corresponding effect control, a corresponding video selection page may be popped up on a display interface or jump to a target video library, so as to select a video that has completed capturing from the video selection page or selecting the video to be processed from the target video library. After the confirmation is clicked, the selected video may be used as the video to be processed. A plurality of video frames in the video to be processed are sequentially processed as images to be processed to obtain a target effect video frame corresponding to each video frame. The target effect video is determined based on a plurality of target effect video frame corresponding to the plurality of video frames.

If the effect processing is performed on the screen recording video, in order to improve the user's interactive experience, a video content selection control (such as a “confirm” button shown in FIG. 2) may be displayed on the display interface when the video is uploaded, so as to determine, based on the video content selection control, at least one video frame that needs effect processing to achieve a technical effect of only performing effect processing on some video frames in the video to be processed. For example, after the video uploading is completed, the video content selection control shown in FIG. 2 may be popped up. Optionally, the video content selection control is displayed in the form of a progress bar, and the user may adjust the position of the progress bar according to an actual requirement to determine some video frames that need effect processing and use some video frames as the images to be processed. As shown in FIG. 2, a left control and a right control may be adjusted, and the progress bar is adjusted to 0:07 seconds (S) and 0:10 seconds (S), so that the video frame to be processed in this time period is used as the image to be processed. Based on the foregoing manner, an effect of performing effect processing on some video frames in the recorded video is achieved.

At S120: determine an object structural feature within the image to be processed corresponding to a target object and determine a style texture feature corresponding to a reference style image to be applied.

Herein, the target object may be at least one target subject in the entry image, and the target subject may be a user, an animal, or the like. That is, the target object may be any object having facial contour information or may be any object capable of obtaining structural features. Correspondingly, the structural feature may be understood as the structural information of the target object. The reference style image to be applied is an image whose style texture feature needs to be obtained. The reference style image to be applied may be one or more, and if multiple, the reference style image to be applied may be preselected or dynamically selected in the video effect processing process, that is, the video image to be processed may be displayed while processing. In the display process, if the style needs to be replaced, the reference style image to be applied may be retriggered to be selected, so as to process the subsequent video frame to be processed into the style texture feature corresponding to the reselected to-be-applied reference style feature. The style of the reference style image to be applied may be any one or more of a Japanese style, an American style, a European style, a Hong Kong style, a Korean style, or the like.

For example, the structure information corresponding to the target object in the image to be processed and the style texture feature corresponding to the reference style image to be applied may be obtained through a pre-trained and deployed feature extraction model; the structure information corresponding to the target object in the image to be processed may be obtained through a pre-trained and deployed feature extraction model, and the style texture feature corresponding to the reference style image to be applied is extracted from a pre-stored style texture library; and the image to be processed and the reference style image to be applied may be respectively input into the corresponding feature extraction model to obtain the structure information of the target object in the image to be processed, and meanwhile, the style texture feature corresponding to the reference style image to be applied is extracted.

It should be noted that the target object in the image to be processed may be one or more. If it is one, only the object structural feature of the target object needs to be extracted. If there are a plurality, object structural features of each target object may be extracted sequentially. The target object that needs to be processed may also be preset before image processing, and in this case, even if the image to be processed includes a plurality of objects, only a preset target object may be processed to obtain the structural feature of the target object.

At S130: determine a target style image corresponding to the image to be processed based on the object structural feature and the style texture feature.

Herein, the target style image may be an image obtained by fusing the object structural feature and the style texture feature. The style texture feature is corresponding to the entire reference style image to be applied. Correspondingly, after the object structural feature and the style texture feature are fused, a target style image may be obtained after the whole image to be processed is performed stylization processing.

For example, the style transfer may be completed according to the object structural feature and the style texture feature, generating the target style image that adjusts the entire texture feature of the image to be processed to the style texture feature.

For example, based on S120, the object structural feature within the image to be processed corresponding to the target object may be obtained, and the style texture feature is determined. Through the fusion processing of the object structural feature and the style texture feature, the target style image may be obtained. At this time, the obtained target style image not only performs stylization processing on the target object in the image to be processed, but also performs stylization processing on the background information in the image to be processed, so that the effect of stylization processing comprehensiveness is achieved.

Based on the foregoing technical solution, the style texture feature of the reference style image to be applied corresponds to at least one of: a comic style texture feature, an epoch style texture feature, or a regional style texture feature. The comic style texture feature may be understood as a texture feature corresponding to a comic style, for example, a Japanese style, an American style, a European style, a Hong Kong style, a Korean style, and the like; the epoch style texture feature may be a texture feature corresponding to the epoch information, for example, the epoch information may be a Tang style texture, a Song style texture, a Ming style texture, a national style texture, and the like; and the regional style texture feature is a texture feature corresponding to the geographic area information, for example, a style texture feature corresponding to an area A and an area B.

According to the technical scheme of the embodiments of the present disclosure, after the image to be processed is obtained, the object structural feature within the image to be processed corresponding to the target object and the style texture feature corresponding to the reference style image to be applied can be extracted. Then, the target style image corresponding to the image to be processed is determined based on the object structural feature and the style texture feature, and finally the target effect video is determined according to the target style image of the at least one image to be processed. According to the technical scheme provided by the embodiments of the present disclosure, the structural features of the target object and the style texture feature can be fused to obtain a target effect image that performs stylized processing on the entire image to be processed, achieving a comprehensive effect of effect processing. When displaying the effect image, the user's appreciation experience can be improved.

Based on the above technical solution, the image may be processed based on the above-mentioned technical solution to generate a corresponding effect video. In this case, each effect video frame in the effect video may be processed in the foregoing manner. That is, in this case, each effect video frame in the effect video is a video frame that performs comprehensive stylization processing on the entire image content.

Optionally, if a captured effect video is detected or an uploaded screen recording video is received, a plurality of video frames in the captured effect video or the screen recording video are respectively used as the images to be processed, and a target style image corresponding to each image to be processed is determined. A plurality of target style images corresponding to images to be processed are joined to obtain a target effect video.

Herein, the at least one video frame may be one or more video frames. That is, each video frame may be processed in sequence, or the image to be processed may be determined from the video frame to be processed according to a preset processing rule. Optionally, the processing rule may be frame extraction processing, for example, the video frames with a preset number of frames is used as the images to be processed. The preset number of frames may be one frame, two frames, etc., and the preset number of frames may be set according to actual needs. The target effect video may be an effect video obtained by splicing a plurality of target style images.

For example, in a video capturing process, if an effect video frame is to be generated, the effect prop provided by the embodiments of the present disclosure may be triggered. In this case, the video frame collected in sequence may be used as the image to be processed, or the corresponding video frame may be extracted as the image to be processed according to a preset processing rule, and the foregoing steps may be performed to obtain an effect image (target style image) for performing stylization processing on the entire background image and the target object of each image to be processed, and the target style image may be spliced according to a collecting timestamp of each image to be processed to obtain the target effect video. Alternatively, after the effect video control is triggered, the video to be processed that need effect processing is uploaded, and each video frame in the video to be processed or a video frame with a preset number of frames is used as the image to be processed. The target style image corresponding to each image to be processed is determined by using the foregoing steps. Splicing the corresponding target style images according to the recording timestamp corresponding to each image to be processed to obtain the target effect video. Whether real-time processing or post-processing of the recorded video is performed, the obtained effect video frame is an image obtained after the entire image is performed stylization processing, so as to achieve the technical effect of image content processing comprehensiveness.

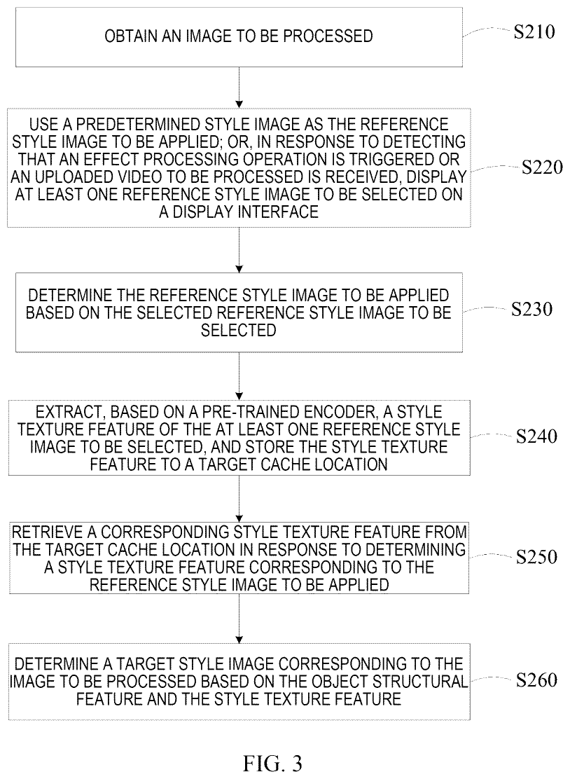

FIG. 3 is a schematic flowchart of a method for processing image provided by the embodiments of the present disclosure. Based on the aforementioned embodiments, the reference style image to be applied and corresponding style texture features may be determined. The specific implementation can be found in the technical solution of this embodiment. Herein, technical terms that are the same or corresponding to the above embodiments will not be repeated here.

As shown in FIG. 3, the method includes the following steps.

At S210, obtain an image to be processed.

At S220, use a predetermined style image as the reference style image to be applied; or, in response to detecting that an effect processing operation is triggered or an uploaded video to be processed is received, display at least one reference style image to be selected on a display interface.

It should be noted that, different user have a certain difference from the preference of different style features, so that the reference style images of different style features may be placed on the public network for voting selection, and the style image with the highest selection rate is used as the reference style image to be applied, that is, the selected reference style image to be applied may be used as a preset style image. Certainly, in order to improve the autonomous selectivity of user to the reference style image to be applied, a plurality of reference style images may be set in the development stage, so that after the corresponding effect prop is triggered or the video to be processed is uploaded, a style image selection list may be popped up on the display interface, or may be jumped to a style image selection library. The user may select the favorite style image from the presented to-be-selected reference style image according to the demand and use it as the reference style image to be applied.

It should be noted that a timing module may be further configured to use a default to-be-selected reference style image as the reference style image to be applied if the image selection list or the waiting duration of the style image selection library reaches a preset duration threshold.

It may be understood that the method for determining the reference style image to be applied includes at least two types. The first type may be a default style image set by developers at the development stage of the application, or the corresponding questionnaire is sent to users, and the default style image is determined according to the questionnaire result of users. In the second way, in order to improve the interactivity between users, at least one reference style image to be selected may be displayed in a target area of the display interface, so that the user may select the corresponding reference style image to be applied autonomously.

S230: determine the reference style image to be applied based on the selected reference style image to be selected.

For example, the user may select a preferred style image from the presented at least one reference style image to be selected and use it as the reference style image to be applied. Alternatively, if the trigger selection of the reference style image to be selected within a preset duration is not detected, the pre-calibrated reference style image to be selected may be used as the reference style image to be applied. The pre-calibrated reference style image to be selected may be randomly set, or the reference style image to be selected with the highest favorability may be determined according to the questionnaire result.

For example, the user may trigger any style image from a display page for the reference style image to be selected according to the requirement, and use it as the reference style image to be applied. To improve the efficiency of selecting the reference style image to be applied by the user, a historical selection rate of each reference style image to be selected may be counted, sorted and displayed according to the historical selection rate, so that the user quickly selects the reference style image to be applied meeting the demand.

S240, extract, based on a pre-trained encoder, a style texture feature of the at least one reference style image to be selected, and store the style texture feature in a target cache location.

Herein, the encoder is composed of an encoder model and a decoder model. The target cache location may be a cache space for storing the corresponding style texture features generated.

In an actual application process, feature extraction may be performed on the reference style image to be selected based on the encoder obtained by training, to obtain a corresponding style texture feature. The extracted style texture features are stored in a target cache location, so that after the reference style image to be applied is determined, the style texture feature matching the reference style image to be applied may be retrieved from the target cache location.

It may be understood that the style texture feature corresponding to the reference style image to be selected may be predetermined and stored, so that when the reference style image to be applied is determined in the actual application, the corresponding style texture feature may be retrieved from the stored style texture feature for processing.

It should be noted that the encoder in the embodiments of the present disclosure includes at least two branch structures, a first branch structure is used for extracting structural features, a second branch structure is used for extracting texture features, the structural features comprise object structural features and style structural features, the texture feature comprise object texture features and style texture features, and the branch structures comprise at least one convolutional layer.

Herein, an object structural feature may be a line feature corresponding to an object, and a style structural feature is a feature corresponding to a line structure of the entire image. An object texture feature may be a feature formed by information such as color and texture of the object. Correspondingly, a style texture feature is a feature corresponding to each pixel texture information extracted from the reference style image to be applied.

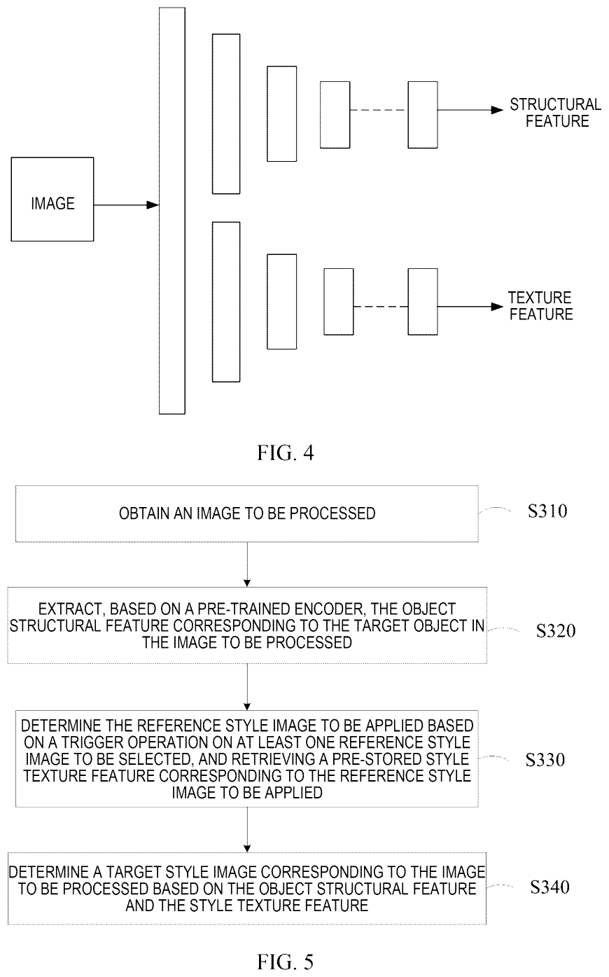

For a structure of an encoder provided in the embodiments of the present disclosure, reference may be made to the schematic diagram shown in FIG. 4. The encoder includes at least two branch structures, and each branch structure includes at least one convolutional layer. The convolutional layer is configured to extract a corresponding feature, for example, the first branch structure is configured to extract a structural feature, and the second branch structure is configured to extract a texture feature. To improve accuracy and efficiency of feature extraction, at least one convolutional layer is used for downsampling to obtain corresponding structural features and texture features.

According to the embodiment of the present disclosure, the encoder is arranged as such structure, the corresponding structural features are respectively extracted from the two branch structures, so that the corresponding features can be fused subsequently to obtain the efficiency of the target style image. Meanwhile, the problem is solved, that is, when the traditional encoder is used for feature extraction by adopting a single branch structure, the structural features and the texture features cannot be decoupled, resulting in the inability to perform corresponding feature extraction subsequently, and thus failing to achieve the effect of comprehensive stylization processing.

At S250: retrieve a corresponding style texture feature from the target cache location in response to determining a style texture feature corresponding to the reference style image to be applied.

It may be understood that, when the style texture feature is determined subsequently, the corresponding style texture feature may be retrieved from the target storage location to perform subsequent stylization processing.

At S260: determine a target style image corresponding to the image to be processed based on the object structural feature and the style texture feature.

According to the technical scheme of the embodiments of the present disclosure, the reference style image to be selected can be predetermined, the style texture feature corresponding to the reference style image to be selected is determined and stored, so that in practical application, the corresponding style texture feature can be selected from the stored style texture feature according to the selected reference style image to be applied, and the subsequent style feature fusion is carried out, so that the target effect video is obtained.

FIG. 5 is a schematic flowchart of a method for processing image provided by the embodiments of the present disclosure. Based on the aforementioned embodiments, the style texture features corresponding to the reference style image to be applied may be predetermined and stored, so that when determining the target style image, the corresponding style texture features may be retrieved for image fusion. The specific implementation may be referred to in the technical solution of this embodiment. Herein, technical terms that are the same or corresponding to the above embodiments will not be repeated here.

As shown in FIG. 5, the method includes the following steps.

At S310, obtain an image to be processed.

At S320: extract, based on a pre-trained encoder, the object structural feature within the image to be processed corresponding to the target object.

For example, the image to be processed is processed according to a pre-trained encoder to obtain an object structural feature and an object texture feature corresponding to the target object in the image to be processed.

S330: determine the reference style image to be applied based on a trigger operation on at least one reference style image to be selected, and retrieve a pre-stored style texture feature corresponding to the reference style image to be applied.

It may be understood that, after uploading the video to be processed or triggering the effect control, at least one reference style image to be selected may be displayed in the style image selection list or the style image selection area displayed in the display interface. The user may select the reference style image to be applied from the at least one reference style image to be selected by clicking or long pressing. At the same time, the corresponding style texture feature may be determined from the pre-stored style texture feature according to an image identification of the reference style image to be applied.

It should be noted that, after determining the style texture feature of the reference style image to be selected, a correspondence relationship between the reference style image to be selected and the corresponding style texture feature may be established. Alternatively, the reference style image to be selected and the corresponding style texture feature may be bound to the corresponding image identification to determine the final style texture feature to be used from the stored style texture features based on the image identification.

S340: determine a target style image corresponding to the image to be processed based on the object structural feature and the style texture feature.

According to the technical scheme provided by the embodiments of the present disclosure, after the corresponding reference style image to be applied is selected by the user, the style texture feature corresponding to the reference style image to be applied can be retrieved from the pre-stored style texture features. The target style image corresponding to the entire image after the style is fused can be obtained based on the style texture feature and the object structural feature, and a comprehensive technical effect in style image processing is achieved.

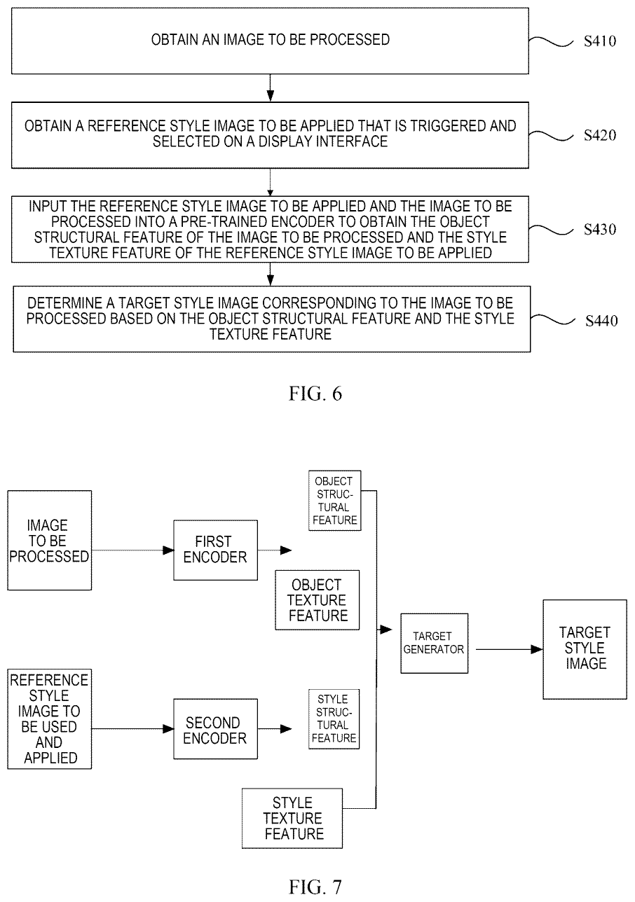

FIG. 6 is a schematic flowchart of a method for processing image provided by the embodiments of the present disclosure. Based on the aforementioned embodiment, the reference style image to be applied is determined in real time. Accordingly, the style texture features corresponding to the reference style image to be applied are also determined in real time. The specific implementation can be referred to in the technical solution of this embodiment. Herein, technical terms that are the same or corresponding to the above embodiments will not be repeated here.

As shown in FIG. 6, the method includes the following steps.

At S410, obtain an image to be processed.

At S420: obtain a reference style image to be applied that is selected on a display interface.

It should be noted that the style texture feature corresponding to the reference style image to be applied may be determined in real time according to the trigger selection of the reference style image to be applied.

At S430, input the reference style image to be applied and the image to be processed into a pre-trained encoder to obtain the object structural feature of the image to be processed and the style texture feature of the reference style image to be applied.

In this embodiment, the number of encoders may be one. If the reference style image to be applied and the image to be processed are processed based on the encoder, it may include: performing style texture feature extraction on the reference style image to be applied based on the encoder, and then extracting the object structural features of the image to be processed based on the encoder to obtain the object structural features.

Under the condition that the number of encoders is limited, using the above method to determine the object structure features and style texture features can achieve the effect of extracting style texture features and object structure features of the corresponding image respectively, and deploy the encoder to terminal devices to achieve universality of use.

On the basis of the above technical solution, inputting the reference style image to be applied and the image to be processed into the pre-trained encoder to obtain the object structural feature of the image to be processed and the style texture feature of the reference style image to be applied comprises: determining identification attributes of the reference image to be applied and the image to be processed, respectively; and extracting, based on the encoder and in accordance with the identification attributes, the object structural feature of the image to be processed and the style texture feature of the reference style image to be applied.

Herein, the identification attribute may be an identification code used to identify the input image. For example, an identification attribute 1 characterizes that the image is an image to be processed, and an identification attribute 2 characterizes that the image is a reference style image to be applied.

For example, when the image is input to the encoder, a corresponding identification attribute may be added to the image to be processed and the reference style image to be applied, and then the object structural feature and the style texture feature of the corresponding image may be extracted according to the identification attribute.

It should be noted that, in an effect video generation process, different style texture feature needs to be displayed for different video segments in the same video. In this case, different style texture feature may be applied to different segments of the video in the process of processing or displaying the effect video.

It should be further noted that, in an actual application process, the number of encoders may be one or more. If there is one encoder, the image may be processed based on the foregoing manner. If there are a plurality of encoders, the corresponding image may be processed based on the plurality of encoders.

Optionally, the number of the encoders includes two, namely a first encoder and a second encoder, respectively. The reference style image to be applied and the image to be processed are input into a pre-trained encoder to obtain the object structural feature of the image to be processed and the style texture feature of the reference style image to be applied may be: extracting, based on the first encoder, features of the image to be processed to obtain the object structural feature and an object texture feature; and extracting, based on the second encoder, features of the reference style image to be applied to obtain the style texture feature and a style structural feature; obtaining the object structural feature and the style texture feature.

Herein, the first encoder may be an encoder configured to perform feature extraction on the image to be processed, and correspondingly, the second encoder may be understood as an encoder for performing feature extraction on the reference style image to be applied.

For example, the object structural feature and the object texture feature corresponding to the target object in the image to be processed may be extracted based on the first encoder; and the style structural feature and the style texture feature of the reference style image to be applied are extracted based on the second encoder.

It should be noted that, the first encoder and the second encoder are merely examples of functions of the encoder, and there is no correspondence relationship, that is, if the first encoder is configured to process the image to be processed, the second encoder processes the reference style image to be applied, and correspondingly, if the first encoder processes the reference style image to be applied, the second encoder processes the image to be processed.

At S440: determine a target style image corresponding to the image to be processed based on the object structural feature and the style texture feature.

Herein, the target generator may be a model for reconstructing an input feature to obtain an image matching the feature.

For example, after obtaining the object structural features and the style structural features, the target style image may be obtained based on the target generator performing reconstruction processing on the object structural features and the style structural features.

For example, referring to FIG. 7, the image to be processed may be input into the first encoder, the first encoder extracts the object structural feature and the object style texture feature of the image to be processed. At the same time, the style texture feature and the style structural feature of the reference style image to be applied are extracted based on the second encoder. The object structural feature and the style texture feature are input into the target generator, and the target style image that fuses the style features of the reference style image to be applied into the image to be processed is reconstructed.

According to the technical scheme of the embodiments of the present disclosure, the reference style image to be applied can be determined in real time, and the style texture feature of the reference style image to be applied and the object structural features of the target object in the image to be processed are extracted based on at least one encoder, so that the target style image is obtained.

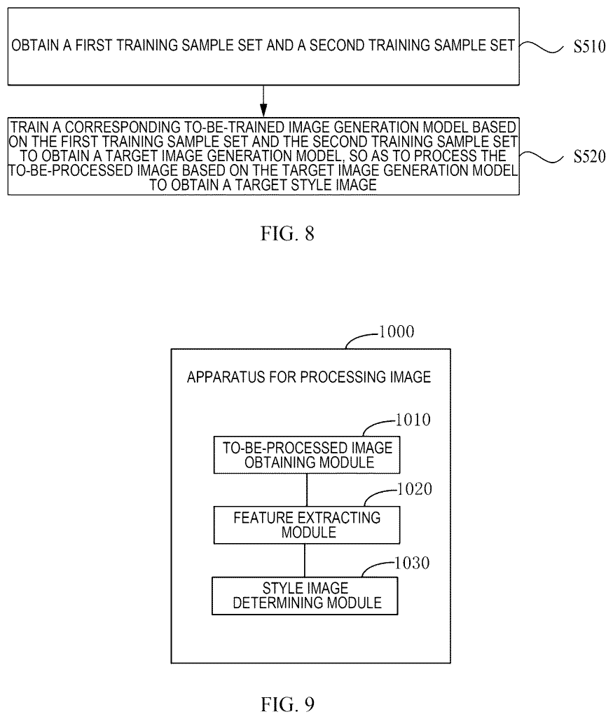

FIG. 8 is a schematic flowchart of training to obtain an image generative model provided by the embodiments of the present disclosure. Based on the aforementioned embodiments, an image generative model can be trained first, which can include an encoder and a target generator to extract corresponding features based on the encoder. Based on the target generator, the extracted features are reconstructed to obtain a target style image. The embodiments of the disclosure may describe the method of training an image generative model.

Technical terms that are the same as or corresponding to the foregoing embodiments are not described herein again.

As shown in FIG. 8, the method includes the following steps.

At S510: obtain a first training sample set and a second training sample set.

Herein, the first training sample set and the second training sample set respectively include a plurality of sample images. Optionally, the first training sample set includes a plurality of first training images, and the first training image may include a corresponding object. The second training sample set includes a plurality of second training images of style features.

At S520, train a corresponding to-be-trained image generation model based on the first training sample set and the second training sample set to obtain a target image generation model, so as to process the image to be processed based on the target image generation model to obtain a target style image.

Herein, the to-be-trained image generative model may be an untrained image generative model, and correspondingly, a target image generative model may be understood as an image generative model obtained after training. The to-be-trained image generative model may include a to-be-trained encoder and a to-be-trained generator. The encoder to be trained is configured to extract structural features and texture features of the corresponding image. The to-be-trained generator may perform reconstruction processing on the extracted features to generate corresponding style images.

On the basis of the above technical scheme, the corresponding to-be-trained image generative model is trained based on the first training sample set and the second training sample set to obtain the target image generative model, which includes: extracting a to-be-trained object structural feature and a to-be-trained object texture feature of a first training image based on an encoder in the first to-be-trained image generative model; and extracting a to-be-trained style texture feature and a to-be-trained style structural feature of a second training image based on an encoder in the second to-be-trained image generative model; reconstructing, based on a first generator in the first to-be-trained image generative model, the to-be-trained object structural feature and the to-be-trained object texture feature to obtain a first reconstructed image; and reconstructing, based on a second generator in the second to-be-trained image generative model, the to-be-trained object structural feature and the to-be-trained style texture feature to obtain a second reconstructed image; based on the first reconstructed image and the corresponding first training image, correcting model parameters in the first to-be-trained image generative model to obtain a first image generative model; based on the second reconstructed image and the corresponding second training image, correcting model parameters in the second to-be-trained image generative model to obtain a second image generative model; and determining a target image generative model based on encoders in the second image generative model and the first image generative model.

Herein, the to-be-trained object structural feature is a structural feature extracted from the first to-be-trained image, and the corresponding to-be-trained object texture feature is a texture feature extracted from the first to-be-trained image. The to-be-trained style texture feature is a texture feature extracted from the second to-be-trained image, and correspondingly, the to-be-trained style structural feature is a structural feature extracted from the second to-be-trained image. That is, the first encoder may extract an object structural code and an object texture code, and the second encoder may extract a style texture code and a style structural code. The style structural code includes image structural information, and the structural information mainly includes contents such as an overall layout and lines. The style texture code includes information such as a texture of the image. The object structural features and the object texture feature may be extracted based on the first image generator corresponding to the first encoder and may be reconstructed to obtain the first reconstructed image. The object structural feature and the style texture feature are reconstructed based on the second image generative model corresponding to the second encoder to obtain a second reconstructed image. A first reconstruction loss is determined based on the first reconstructed image and the corresponding first training image to correct the model parameters in the first encoder and the first image generator based on the first reconstruction loss. Meanwhile, a style loss value is determined based on the second reconstructed image and the corresponding second training image, and the model parameters in the second encoder and the second image generator are corrected based on the style loss value.

The corresponding loss function is converged as a training target to obtain the first encoder, the second encoder, and the image generative model. The object structural feature of the image to be processed may be extracted based on the first encoder, and the style texture feature of the reference style image to be applied may be extracted based on the second encoder, and feature fusion processing may be performed on the object structural feature and the style texture feature based on any one image generator to obtain the target style image. Alternatively, the target style image may be obtained by: extracting, based on the first encoder, the object structure features of the image to be processed and the style texture features of the reference style image to be applied; fusing, based on any image generator, the object structural features and style texture features.

The technical solution provided by the embodiments of the present disclosure trains the corresponding image generative model to be trained based on the first training sample set and the second training sample set to obtain the target image generative model, and processes the image to be processed and the corresponding reference style image to be applied based on the target image generative model to obtain the target style image, thereby achieving a comprehensive technical effect of style texture feature processing.

FIG. 9 is a structural block diagram of an apparatus for processing image provided by the embodiments of the present disclosure, which may perform the method for processing image provided by any embodiment of the present disclosure and has functional modules and beneficial effects corresponding to the execution method. As shown in FIG. 9, the apparatus 1000 may include an image to be processed obtaining module 1010, a feature extracting module 1020, and a style image determining module 1030.

The image to be processed obtaining module 1010 is configured to obtain an image to be processed.

The feature extraction module 1020 is configured to determine an object structural feature within the image to be processed corresponding to a target object and determine a style texture feature corresponding to a reference style image to be applied.

The style image determining module 1030 determines a target style image corresponding to the image to be processed based on the object structural feature and the style texture feature.

On the basis of the above technical solution, the image to be processed obtaining module is set to obtain the image to be processed by: in response to detecting that an effect processing operation is triggered, collecting the image to be processed; or determining at least one video frame within an uploaded video to be processed as the image to be processed.

On the basis of the above technical solution, the reference style image to be applied is determined by: determining a predetermined style image as the reference style image to be applied; or in response to detecting that an effect processing operation is triggered or an uploaded video to be processed is received, displaying at least one reference style image to be selected on a display interface, determining the reference style image to be applied based on the selected reference style image to be selected.

On the basis of the above technical solution, the apparatus 1000 further includes a storage module configured to:
extracting, based on a pre-trained encoder, a style texture feature of the at least one reference style image to be selected, and storing the style texture feature in a target cache location, so as to retrieve a corresponding style texture feature from the target cache location in response to determining a style texture feature corresponding to the reference style image to be applied.

On the basis of the above technical solution, the feature extracting module 1020 is configured to determine the object structural feature and the style texture feature by: extracting, based on apre-trained encoder, the object structural feature within the image to be processed corresponding to the target object; and determining the reference style image to be applied based on a trigger operation on at least one reference style image to be selected, and retrieving a pre-stored style texture feature corresponding to the reference style image to be applied.

On the basis of the above technical solution, the feature extracting module 1020 is further configured to determine the object structural feature and the style texture feature by: obtaining a reference style image to be applied that is selected on a display interface; and inputting the reference style image to be applied and the image to be processed into a pre-trained encoder to obtain the object structural feature of the image to be processed and the style texture feature of the reference style image to be applied.

On the basis of the above technical solution, the feature extracting module 1020 is configured to determine the object structural feature and the style texture feature based on the encoder by: determining identification attributes of the reference image to be applied and the image to be processed, respectively; and extracting, based on the encoder and in accordance with the identification attributes, the object structural feature of the image to be processed and the style texture feature of the reference style image to be applied.

On the basis of the above technical solution, the apparatus 1000 further includes:
an effect video generation module configured for, in response to detecting a captured effect video or receiving an uploaded screen recording video, respectively determining a plurality of video frames in the captured effect video or the screen recording video as the images to be processed, and determining a target style image corresponding to each image to be processed; and joining a plurality of target style images corresponding to images to be processed to obtain a target effect video.

On the basis of the above technical solution, the encoder includes a first encoder and a second encoder, and the feature extracting module 1020 is configured to determine the object structural feature and the style texture feature based on the first encoder and the second encoder by: extracting, based on the first encoder, features of the image to be processed to obtain the object structural feature and an object texture feature; and extracting, based on the second encoder, features of the reference style image to be applied to obtain the style texture feature and a style structural feature; obtaining the object structural feature and the style texture feature.

On the basis of the above technical solution, the style image determining module 1030 is configured to obtain the target style image based on the object structural feature and the style texture feature by: reconstructing, based on a target generator, the object structural feature and the style texture feature to obtain the target style image.

On the basis of the above technical solution, the encoder comprises at least two branch structures, one branch structure is used for extracting structural features, the other branch structure is used for extracting texture features, the structural features comprise object structural features and style structural features, the texture features comprise object texture features and style texture features, and the branch structures comprise at least one convolutional layer.

On the basis of the above technical solution, the style texture feature of the reference style image to be applied corresponds to at least one of: a comic style texture feature, an epoch style texture feature, or a regional style texture feature.

According to the technical scheme of the embodiments of the present disclosure, after the image to be processed is obtained, the object structural feature within the image to be processed corresponding to the target object and the style texture feature corresponding to the reference style image to be applied can be extracted. Then, the target style image corresponding to the image to be processed is determined based on the object structural feature and the style texture feature, and finally the target effect video is determined according to the target style image of the at least one image to be processed. According to the technical scheme provided by the embodiments of the present disclosure, the structural features of the target object and the style texture feature can be fused to obtain a target effect image that performs stylized processing on the entire image to be processed, achieving a comprehensive effect of effect processing. When displaying the effect image, the user's appreciation experience can be improved.

It should be noted that the units and modules included in the foregoing apparatus are only divided according to the function logic, as long as the corresponding functions can be implemented; in addition, the names of the functional units are merely used to facilitate mutual differentiation.

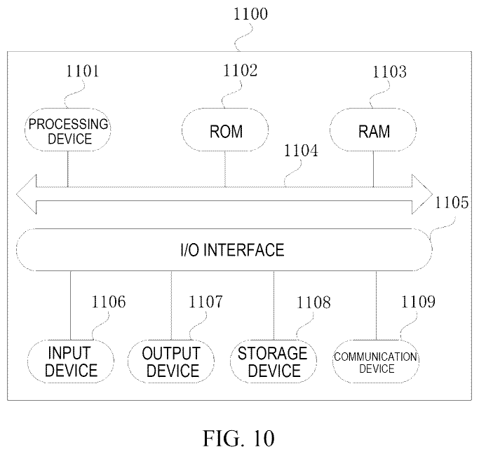

FIG. 10 is a schematic structural diagram of an electronic device provided by the embodiments of the present disclosure. The following refers to FIG. 10, which is a schematic structural diagram of an electronic device 1100 (such as the terminal device or server in FIG. 10) suitable for implementing the embodiments of the present disclosure. The terminal device in the embodiments of the present disclosure may include a mobile terminal such as a mobile phone, a notebook computer, a digital broadcast receiver, a personal digital assistant (PDA), a portable android device (PAD), a portable media player (PMP), an in-vehicle terminal (for example, an in-vehicle navigation terminal), and a fixed terminal such as a digital television (TV), a desktop computer, or the like. The electronic device shown in FIG. 10 is merely an example.

As shown in FIG. 10, the electronic device 1100 may include a processing device (for example, a central processor, a graphics processor, etc.) 1101, which may perform various appropriate actions and processing according to a program stored in a read only memory (ROM) 1102 or a program loaded into a random access memory (RAM) 1103 from a storage device 1108. In the RAM 1103, various programs and data required by the operation of the electronic device 1100 are also stored. The processing device 1101, the ROM 1102, and the RAM 1103 are connected to each other through a bus 1104. An input/output (I/O) interface 1105 is also connected to the bus 1104.

Generally, the following devices may be connected to the I/O interface 1105: an input device 1106 including, for example, a touch screen, a touch pad, a keyboard, a mouse, a camera, a microphone, an accelerometer, a gyroscope, etc.; an output device 1107 including, for example, a liquid crystal display (LCD), a speaker, a vibrator, etc.; a storage device 1108 including, for example, a magnetic tape, a hard disk, etc.; and a communication device 1109. The communication device 1109 may allow the electronic device 1100 to communicate wirelessly or wired with other devices to exchange data. While FIG. 10 shows an electronic device 1100 having various devices, it should be understood that it is not required to implement or have all illustrated devices. More or fewer devices may alternatively be implemented or provided.

In an embodiment, the process described above with reference to the flowchart may be implemented as a computer software program according to the embodiments of the present disclosure. For example, the embodiments of the present disclosure include a computer program product comprising a computer program embodied on a non-transitory computer readable medium, the computer program comprising program code for performing the method shown in the flowchart. In such embodiment, the computer program may be downloaded and installed from the network through the communication device 1109, or installed from the storage device 1108, or from the ROM 1102. When the computer program is executed by the processing device 1101, the foregoing functions defined in the method of the embodiments of the present disclosure are performed.

The electronic device provided by the embodiments of the present disclosure and the method for processing image provided in the above embodiments belong to the same inventive concept, technical details not described in detail in this embodiment may refer to the foregoing embodiments, and the present embodiment has the same beneficial effects as the foregoing embodiments.

The embodiments of the present disclosure provide a computer storage medium having a computer program stored thereon, the program, when executed by a processor, implements the method for processing image provided in the foregoing embodiments.

It should be noted that in the context of the present disclosure, a computer readable medium may be a tangible medium that may contain or store a program for use by or in conjunction with an instruction execution system, apparatus, or device. The computer readable medium may be a computer readable signal medium or a computer readable storage medium or any combination of the two. The computer readable storage medium may be, for example, but is not limited to: an electrical, magnetic, optical, electromagnetic, infrared, or semiconductor system, apparatus, or device, or any combination thereof. More specific examples of computer readable storage medium may include, but are not limited to: an electrical connection having one or more wires, a portable computer disk, a hard drive, a random access memory (RAM), a read only memory (ROM), an erasable programmed read-only memory (EPROM or flash memory), fiber optics, a portable compact disk read-only memory (CD-ROM), an optical storage device, an magnetic storage device, or any suitable combination of the above. In the present disclosure, a computer readable storage medium may be any tangible medium that contains or stores a program for use by or in connection with an instruction execution system, apparatus, or device. In the present disclosure, a computer readable signal medium may include a data signal propagated in a baseband or as part of a carrier wave, carrying computer readable program code therein. Such propagated data signal may take many forms, including but not limited to electromagnetic signals, optical signals, or any suitable combination of the above. A computer readable signal medium may also be any computer readable medium other than a computer readable storage medium that may send, propagate, or transmit a program for use by or in connection with an instruction execution system, apparatus, or device. Program code embodied on a computer readable medium may be transmitted using any suitable medium, including but not limited to: wire, optical cable, RF (radio frequency), etc., or any suitable combination of the above.

In some implementations, clients and servers can communicate with any currently known or future developed network protocol such as HyperText Transfer Protocol (HTTP) and can interconnect with any form or medium of digital data communication (e.g., communication networks). Examples of communication networks include local area networks (LANs), wide area networks (WANs), the Internet (such as the Internet), and end-to-end networks (e.g., ad hoc end-to-end networks), as well as any currently known or future developed networks.

The computer-readable medium described above may be included in the electronic device; or may be separately present without being assembled into the electronic device.

The computer-readable medium carries one or more programs, and when the one or more programs are executed by the electronic device, the electronic device is caused to:
obtain an image to be processed;
determine an object structural feature within the image to be processed corresponding to a target object and
determining a style texture feature corresponding to a reference style image to be applied; and
determine a target style image corresponding to the image to be processed based on the object structural feature and the style texture feature.

The computer-readable medium carries at least one program, and when the at least one program is executed by the electronic device, the electronic device can: write a computer program code for performing the operation of the present disclosure in one or more programming languages or a combination thereof, wherein the programming language includes an object-oriented programming language such as Java, Smalltalk, C++, and also includes a conventional procedural programming language such as “C” language or a similar programming language. The program code can be executed entirely on the user's computer, partially on the user's computer, as an independent software package, partially on the user's computer and partially on a remote computer, or completely on a remote computer or server. In the case of a remote computer, the remote computer can be connected to the user's computer through any type of network including a local area network (LAN) or a wide area network (WAN), or can be connected to an external computer (for example, using an Internet service provider to connect through the Internet).

The flowcharts and the block diagrams in the drawings illustrate system architectures, functions and operations that may be implemented based on the system, method and computer program product according to various embodiments of the present disclosure. In this regard, each block in the flowcharts or the block diagrams can represent one module, a program segment or a part of a code, and the module, the program segment or the part of the code includes at least one executable instruction for implementing specific logic functions. It should also be noted that, in some alternative implementations, the functions noted in the blocks may also occur in a sequence different from those illustrated in the drawings. For example, two consecutive blocks may be executed substantially in parallel, and may sometimes be executed in an opposite order, depending on the functions involved. It should also be noted that each block in the block diagrams and/or the flowcharts, and combinations of the blocks in the block diagrams and/or the flowcharts can be implemented in a dedicated hardware-based system that performs the specified functions or operations, or can be implemented by the combination of dedicated hardware and computer instructions.

The modules described in the embodiments of the present disclosure may be implemented by way of software or hardware. In some cases, the names of the modules do not constitute limitations to the modules themselves. For example, the first obtaining unit may be further described as “a unit that obtains at least two internet protocol addresses”.

The functions described above herein may be at least partially performed by one or more hardware logic components. For example, non-restrictively, example types of hardware logic components that may be used include: a field programmable gate array (FPGA), an application-specific integrated circuit (ASIC), an application-specific standard parts (ASSP), a system-on-chip (SOC), a complex programmable logic device (CPLD), and the like.

In the context of the present disclosure, the machine-readable medium may be a tangible medium that may contain or store a program used by or used in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a RAM, a ROM, an EPROM or a flash memory, an optical fiber, a CD-ROM, an optical storage device, a magnetic storage device, or any suitable combination thereof. The description is merely an illustration of the preferred embodiments of the present disclosure and the principles of the applied technology.

Further, while operations are depicted in a particular order, this should not be understood to require that these operations be performed in the particular order shown or in sequential order. In certain circumstances, multitasking and parallel processing may be advantageous.

1-15. (canceled)

16. A method for processing image, comprising:
obtaining an image to be processed;
determining an object structural feature within the image to be processed corresponding to a target object and determining a style texture feature corresponding to a reference style image to be applied; and
determining a target style image corresponding to the image to be processed based on the object structural feature and the style texture feature.

17. The method of claim 16, wherein the obtaining the image to be processed comprises:
in response to detecting that an effect processing operation is triggered, collecting the image to be processed; or
determining at least one video frame within an uploaded video to be processed as the image to be processed.

18. The method of claim 16, wherein the reference style image to be applied is determined by:
determining a predetermined style image as the reference style image to be applied; or
in response to detecting that an effect processing operation is triggered or an uploaded video to be processed is received, displaying at least one reference style image to be selected on a display interface;
determining the reference style image to be applied based on the selected reference style image to be selected.

19. The method of claim 18, further comprising:
extracting, based on a pre-trained encoder, a style texture feature of the at least one reference style image to be selected, and storing the style texture feature in a target cache location, so as to retrieve a corresponding style texture feature from the target cache location in response to determining a style texture feature corresponding to the reference style image to be applied.

20. The method of claim 16, wherein the determining the object structural feature within the image to be processed corresponding to the target object and determining the style texture feature corresponding to the reference style image to be applied comprises:
extracting, based on a pre-trained encoder, the object structural feature within the image to be processed corresponding to the target object; and
determining the reference style image to be applied based on a trigger operation on at least one reference style image to be selected, and retrieving a pre-stored style texture feature corresponding to the reference style image to be applied.

21. The method of claim 16, wherein the determining the object structural feature within the image to be processed corresponding to the target object and determining the style texture feature corresponding to the reference style image to be applied comprises:
obtaining the reference style image to be applied that is selected on a display interface; and
inputting the reference style image to be applied and the image to be processed into a pre-trained encoder to obtain the object structural feature of the image to be processed and the style texture feature of the reference style image to be applied.

22. The method of claim 21, wherein the inputting the reference style image to be applied and the image to be processed into the pre-trained encoder to obtain the object structural feature of the image to be processed and the style texture feature of the reference style image to be applied comprises:
determining identification attributes of the reference style image to be applied and the image to be processed, respectively; and
extracting, based on the pre-trained encoder and in accordance with the identification attributes, the object structural feature of the image to be processed and the style texture feature of the reference style image to be applied.

23. The method of claim 21, wherein the pre-trained encoder comprises a first encoder and a second encoder, and the inputting the reference style image to be applied and the image to be processed into the pre-trained encoder to obtain the object structural feature of the image to be processed and the style texture feature of the reference style image to be applied comprises:
extracting, based on the first encoder, features of the image to be processed to obtain the object structural feature and an object texture feature; and
extracting, based on the second encoder, features of the reference style image to be applied to obtain the style texture feature and a style structural feature;
obtaining the object structural feature and the style texture feature.

24. The method of claim 16, wherein the determining the target style image corresponding to the image to be processed based on the object structural feature and the style texture feature comprises:
reconstructing, based on a target generator, the object structural feature and the style texture feature to obtain the target style image.

25. The method of claim 16, further comprising:
in response to detecting a captured effect video or receiving an uploaded screen recording video, respectively determining a plurality of video frames in the captured effect video or the uploaded screen recording video as the images to be processed, and determining a target style image corresponding to each image to be processed; and
joining a plurality of target style images corresponding to images to be processed to obtain a target effect video.

26. The method of claim 19, wherein the pre-trained encoder comprises at least two branch structures, a first branch structure is used for extracting structural features, a second branch structure is used for extracting texture features, the structural features comprise object structural features and style structural features, the texture features comprise object texture features and style texture features, and the branch structures comprise at least one convolutional layer.

27. The method of claim 16, wherein the style texture feature of the reference style image to be applied corresponds to at least one of: a comic style texture feature, an epoch style texture feature, or a regional style texture feature.

28. An electronic device comprising:
one or more processors; and
a storage device configured to store one or more programs,
wherein the one or more programs, when executed by the one or more processors, cause the one or more processors to implement acts for processing image, the acts comprising:
obtaining an image to be processed;
determining an object structural feature within the image to be processed corresponding to a target object and determining a style texture feature corresponding to a reference style image to be applied; and
determining a target style image corresponding to the image to be processed based on the object structural feature and the style texture feature.

29. The device of claim 28, wherein the obtaining the image to be processed comprises:
in response to detecting that an effect processing operation is triggered, collecting the image to be processed; or
determining at least one video frame within an uploaded video to be processed as the image to be processed.

30. The device of claim 28, wherein the reference style image to be applied is determined by:
determining a predetermined style image as the reference style image to be applied; or
in response to detecting that an effect processing operation is triggered or an uploaded video to be processed is received, displaying at least one reference style image to be selected on a display interface;
determining the reference style image to be applied based on the selected reference style image to be selected.

31. The device of claim 28, wherein the determining the object structural feature within the image to be processed corresponding to the target object and determining the style texture feature corresponding to the reference style image to be applied comprises:
extracting, based on a pre-trained encoder, the object structural feature within the image to be processed corresponding to the target object; and
determining the reference style image to be applied based on a trigger operation on at least one reference style image to be selected, and retrieving a pre-stored style texture feature corresponding to the reference style image to be applied.

32. The device of claim 28, wherein the determining the object structural feature within the image to be processed corresponding to the target object and determining the style texture feature corresponding to the reference style image to be applied comprises:
obtaining the reference style image to be applied that is selected on a display interface; and
inputting the reference style image to be applied and the image to be processed into a pre-trained encoder to obtain the object structural feature of the image to be processed and the style texture feature of the reference style image to be applied.

33. The device of claim 28, wherein the determining the target style image corresponding to the image to be processed based on the object structural feature and the style texture feature comprises:
reconstructing, based on a target generator, the object structural feature and the style texture feature to obtain the target style image.

34. The device of claim 28, further comprising:
in response to detecting a captured effect video or receiving an uploaded screen recording video, respectively determining a plurality of video frames in the captured effect video or the uploaded screen recording video as the images to be processed, and determining a target style image corresponding to each image to be processed; and
joining a plurality of target style images corresponding to images to be processed to obtain a target effect video.

35. A non-transitory storage medium comprising computer-executable instructions, wherein the computer-executable instructions, when executed by a computer processor, perform acts for processing image, the acts comprising:
obtaining an image to be processed;
determining an object structural feature within the image to be processed corresponding to a target object and determining a style texture feature corresponding to a reference style image to be applied; and
determining a target style image corresponding to the image to be processed based on the object structural feature and the style texture feature.
